(19) United States
(12) Patent Application Publication
(10) Pub. No.: US 2005/0127199 A1
(43) Pub. Date: Jun. 16, 2005

(54) Ornamental fountain

(76) Inventor: Simon Nicholas Richmond, Waterloo (AU)

Correspondence Address: DAVIS WRIGHT TREMAINE, LLP, 2600 CENTURY SQUARE, 1501 FOURTH AVENUE, SEATTLE, WA, 98101-1688, US

(21) Appl. No.: 10/841,801

(22) Filed: May 7, 2004

(30) Foreign Application Priority Data
Dec. 10, 2003 (AU) 2003906885

(51) Int. Cl. B05B 17/08

(52) U.S. Cl. 239/18; 239/20; 239/17

(57) ABSTRACT

An ornamental fountain (10) is disclosed. The fountain comprises an ornamental body portion (12), and a liquid outlet (18) accommodated on the body portion (12), the liquid outlet being connectable during use to a source of pressurised liquid and being arranged such that during use when pressurised liquid is supplied to the liquid outlet (18) a liquid stream is produced. The fountain (10) also comprises a light emitting device (20) accommodated on the body portion (12) and arranged such that during use when electrical power is supplied to the light emitting device (20), the light emitting device (20) emits light in a direction which intersects with the liquid stream and at least a portion of the emitted light travels along the liquid stream in the same direction as the liquid stream.

### CROSS REFERENCE TO RELATED APPLICATION(S)

This application claims priority to Australian Patent Application No. 2003906885, filed Dec. 10, 2003.

### BACKGROUND OF THE INVENTION

It is known to provide an ornamental fountain of the type which includes an ornamental body portion having a liquid outlet accommodated on the body portion such that during use when the liquid outlet is connected to a source of pressurised liquid, a liquid stream is produced. Generally, a separate liquid receptacle is provided to receive the liquid stream and a pump re-circulates fluid in the receptacle to the ornamental fountain.

In order to enhance the visual appearance of such ornamental fountains, it is known to provide a light emitting device such as a garden light and to arrange the garden light so that light from the garden light illuminates the liquid stream.

However, this arrangement for enhancing the visual appearance of the ornamental fountain is cumbersome and relies on accurate coordination of the ornamental fountain and the garden light in order to achieve an enhanced appearance.

### FIELD OF THE INVENTION

The present invention relates to an ornamental fountain.

### BRIEF SUMMARY OF THE INVENTION

In accordance with an aspect of the present invention, there is provided an ornamental fountain, said fountain comprising:
an ornamental body portion;
a liquid outlet accommodated on the body portion, the liquid outlet being connectable during use to a source of pressurised liquid and being arranged such that during use when pressurised liquid is supplied to the liquid outlet a liquid stream directed forwardly of the body portion is produced;
a light emitting device accommodated on the body portion and arranged such that during use when electrical power is supplied to the light emitting device, the light emitting device emits light in a direction which intersects with the liquid stream and at least a portion of the emitted light travels along the liquid stream in the same direction as the liquid stream.

In this way, by accommodating a light emitting device on the body portion, emitted light is accurately aligned with the liquid stream for a desirable enhanced appearance. Accommodating the light emitting device on the body portion also enables the light emitting device to be concealed in the ornamentation of the fountain, and has the effect of lowering the production costs relative to separate fountain and light devices. In addition, since the light emitting device is accommodated on the body portion and arranged so as to emit light during use which intersects with the liquid fountain and at least partially travels along the liquid stream in the same direction as the liquid stream, a light pipe effect is achieved with the liquid stream which significantly contributes to enhancement of the appearance of the fountain.

In one embodiment, the fountain further comprises a control unit arranged during use to not transfer electrical power to the light emitting device during daytime and to transfer electrical power to the light emitting device during nighttime. For this purpose, the fountain may further comprise a light sensitive device arranged to generate an electrical signal indicative of the light intensity incident on the light sensitive device, and a control unit arranged to control illumination of the light emitting device in response to the electrical signal. The light sensitive device may be a light dependent resistor, a photo transistor or a solar cell, and the control unit may be arranged to transfer electrical power to the light emitting device when an electrical current through the light dependent resistor, photo transistor or solar cell is below a predetermined threshold.

In one arrangement, the light sensitive device is accommodated on the body portion.

In one arrangement, the body portion is hollow and the control unit is disposed inside the body portion.

The fountain may further comprise a liquid pump in communication with the liquid outlet and arranged during use to supply pressurised liquid to the liquid outlet. The liquid pump may be disposed inside the body portion.

In one arrangement, the fountain further comprises a transformer arranged to supply electrical power to the light emitting device and the liquid pump. The transformer may include a primary winding, a first secondary winding in circuit with the light emitting device, and a second secondary winding in circuit with the liquid pump.

The liquid outlet may form part of a nozzle.

In one embodiment, the fountain further comprises a liquid duct connected at a first end to the liquid outlet and connectable at a second opposite end to a liquid pump.

In one arrangement, the fountain further comprises a plurality of light emitting devices, at least one of which is arranged such that during use when electrical power is supplied to the light emitting device, the light emitting device emits light in a direction which intersects with the liquid stream and at least a portion of the emitted light travels along the liquid stream in the same direction as the liquid stream.

The light emitting device may be a halogen lamp or at least one light emitting diode. The or each light emitting device may be arranged to emit coloured light.

In one arrangement, the body portion is configured so as to resemble a fish.

In one embodiment, the fountain further comprises at least one rechargeable battery and a solar power converting device arranged to convert solar power to electrical power and thereby generate a recharge current useable to recharge the at least one rechargeable battery during daytime. The solar power converting device may be at least one solar panel.

### BRIEF DESCRIPTION OF THE SEVERAL VIEWS OF THE DRAWING(S)

The present invention will now be described, by way of example only, with reference to the accompanying drawings, in which:

FIG. 1 is a diagrammatic perspective view of an ornamental fountain in accordance with an embodiment of the present invention;

FIG. 2 is a diagrammatic cross sectional view of the ornamental fountain shown in FIG. 1;

FIG. 3 is a schematic circuit diagram which illustrates an example circuit configuration for the ornamental fountain; and

FIG. 4 is a schematic circuit diagram which illustrates a further example circuit configuration for the ornamental fountain.

### DETAILED DESCRIPTION OF THE INVENTION

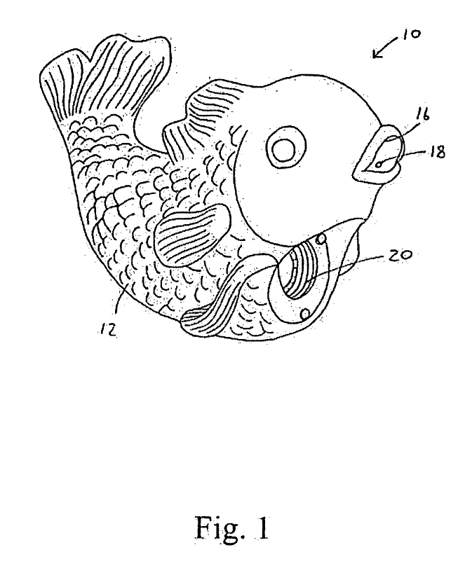

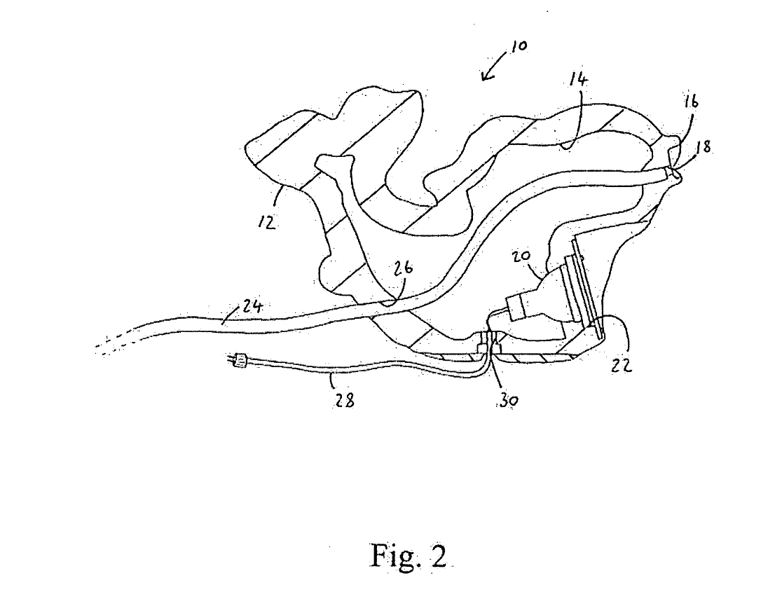

Referring to FIGS. 1 and 2 of the drawings, there is shown an ornamental fountain 10 which in this example is configured so as to provide the appearance of a fish. However, it will be understood that any ornamental design may be used.

The ornamental fountain 10 includes a body portion 12, in this example formed of corrosion resistant material such as plastics resin material. However, it will be understood that any suitable material is envisaged.

As shown more particularly in FIG. 2, the body portion 12 is hollow and defines a cavity portion 14.

In this example, the body portion 12 includes a mouth portion 16 on which is accommodated a first aperture 18 which may be in the form of a nozzle. Also accommodated on the body portion is a light emitting device, in this example in the form of a halogen lamp 20 mounted in a second aperture 22. However, it will be understood that other light emitting devices are envisaged, such as light emitting diodes.

The first aperture 18 is connected to a liquid duct 24 which extends from the first aperture 18, through the cavity portion 14 and through a third aperture 26 formed in the body portion 12. The arrangement is such that, during use, liquid under pressure is supplied to the liquid duct 24 and a liquid stream emanating from the first aperture 18 is produced. Typically, the liquid used is water, although it will be understood that other liquids are envisaged including mixtures of other liquids with water.

The lamp 20 is connected to an electrical cable 28 which extends from a rearward portion of the lamp 20, through the cavity portion 14, and through a fourth aperture 30 formed in the body portion 12. The arrangement is such that, during use, when electrical power is supplied to the electrical cable 28, the lamp 20 emits light.

The lamp 20 is mounted on the body portion 12 and arranged such that light emanating from the lamp 20 intersects with the liquid stream during use and at least a portion of the light travels along the liquid stream in the same direction as the liquid stream.

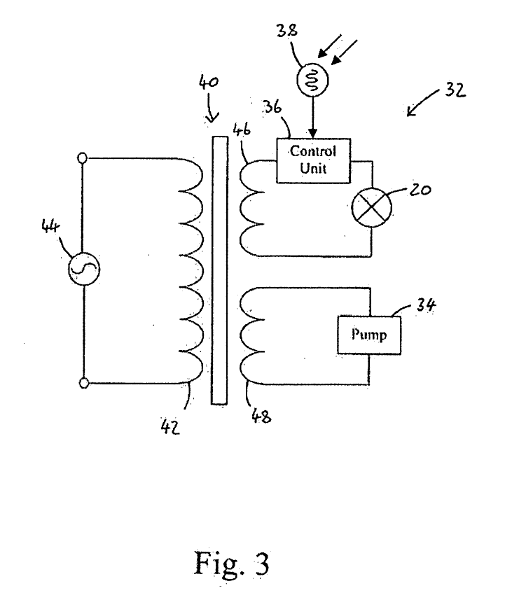

An example circuit 32 for use with the ornamental fountain 10 is shown in FIG. 3.

The circuit 32 includes a liquid pump 34 connectable to the liquid duct 24 such that during use when electrical power is supplied to the pump 34, liquid under pressure is supplied to the first aperture 18 and a liquid stream is produced. It will be understood that the pump 34 used with the ornamental fountain 10 should provide sufficient pressure during use to cause the liquid stream to be directed forwardly of the body portion 12.

The circuit 32 also includes a control unit 36 connectable to the electrical cable 28 and arranged so as to cause the lamp 20 to emit light when electrical power is supplied to the control unit 36. In this example, the control unit 36 is also arranged so as to prevent transfer of electrical power to the lamp 20 in daytime and to transfer electrical power to the lamp 20 at nighttime. For this purpose, any timer or light sensing device may be used, and in this example a light sensor in the form of a light dependent resistor 38 is provided. The light dependent resistor 38 causes an electrical current above a predetermined threshold to flow when light above a predetermined intensity shines on the light dependent resistor 38, and the control unit 36 is arranged to prevent transfer of power to the lamp 20 when the electrical current above the predetermined threshold is received. However, it will be understood that other light sensing arrangements are envisaged, such as photo transistors, solar panels, and so on.

In this example, a power supply which includes a transformer 40 provides electrical power for the control unit 36, the lamp 20 and the pump 34.

In this example, the transformer 40 includes a primary winding 42, a first secondary winding 46 and a second secondary winding 48. In the present arrangement, the transformer 40 is arranged such that each of the first and second secondary windings 46, 48 produces a voltage of approximately 12 volts, although it will be understood that other arrangements are envisaged.

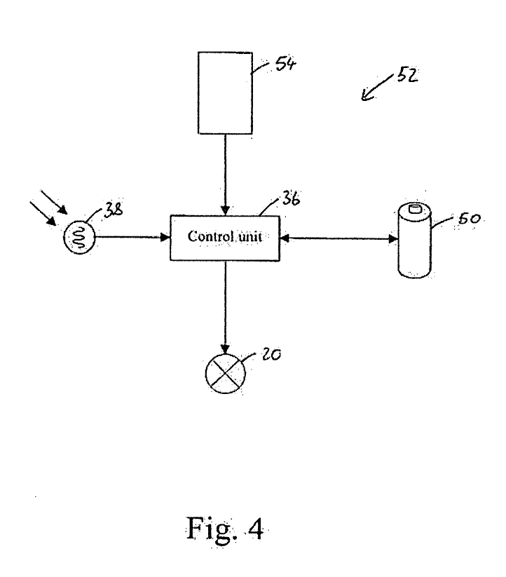

In addition, or alternatively, the ornamental fountain 10 may be arranged to receive power from rechargeable batteries 50 as indicated in alternative circuit 52 shown in FIG. 4. As with the circuit 32 shown in FIG. 3, the control unit 36 is arranged to supply electrical power, in this case from the rechargeable batteries 50, to the lamp 20 when light incident on the light sensitive device 38 falls below a predetermined threshold. In this example, the control unit 36 is also arranged to coordinate supply of a recharging electrical current from a solar power converting device, in this example solar panels 54, to the rechargeable batteries 50 so that recharging of the batteries 50 may occur during daytime.

Although the present example is described in relation to a light sensor and control unit which are separate to the body portion 12, it will be understood that the light sensor may be incorporated into the body portion and the control unit 36 disposed inside the cavity portion 14. Similarly, although with the present example the pump 34 is separate to the body portion, it will be understood that the pump 34 may be disposed inside the cavity portion 14.

It will be appreciated that although the present example includes one lamp 20 accommodated on the body portion, it will be understood that more than one lamp 20 may be provided. In addition, the or each lamp may be arranged so as to emit light of differing colours.

It will also be appreciated that since with the present example both the control unit 36, lamp 20 and the pump 34 derive power from the same transformer 40, operation of the pump 34 and the lamp 20 may be easily coordinated.

It will also be appreciated that since the ornamental fountain 10 may be used outdoors, the ornamental fountain 10 may be configured so as to be waterproof and substantially resistant to corrosion.

Throughout this specification the term “comprising” is used inclusively, in the sense that there may be other features and/or steps included in the invention not expressly defined or comprehended in the features or steps subsequently defined or described. What such other features and/or steps may include will be apparent from the specification read as a whole.

Modifications and variations as would be apparent to a skilled addressee are deemed to be within the scope of the present invention.

1. An ornamental fountain, said fountain comprising:
an ornamental body portion;
a liquid outlet accommodated on the body portion, the liquid outlet being connectable during use to a source of pressurised liquid and being arranged such that during use when pressurised liquid is supplied to the liquid outlet a liquid stream directed forwardly of the body portion is produced;
a light emitting device accommodated on the body portion and arranged such that during use when electrical power is supplied to the light emitting device, the light emitting device emits light in a direction which intersects with the liquid stream and at least a portion of the emitted light travels along the liquid stream in the same direction as the liquid stream.

2. An ornamental fountain as claimed in claim 1, further comprising a control unit arranged during use to not transfer electrical power to the light emitting device during daytime and to transfer electrical power to the light emitting device during nighttime.

3. An ornamental fountain as claimed in claim 2, further comprising a light sensitive device arranged to generate an electrical signal indicative of the light intensity incident on the light sensitive device, and a control unit arranged to control illumination of the light emitting device in response to the electrical signal.

4. An ornamental fountain as claimed in claim 3, wherein the light sensitive device is a light dependent resistor, a photo transistor or a solar cell, and the control unit is arranged to transfer electrical power to the light emitting device when an electrical current through the light dependent resistor, photo transistor or solar cell is below a predetermined threshold.

5. An ornamental fountain as claimed in claim 4, wherein the light sensitive device is accommodated on the body portion.

6. An ornamental fountain as claimed in claim 3, wherein the body portion is hollow and the control unit is disposed inside the body portion.

7. An ornamental fountain as claimed in claim 1, further comprising a liquid pump in communication with the liquid outlet and arranged during use to supply pressurised liquid to the liquid outlet.

8. An ornamental fountain as claimed in claim 7, wherein the body portion is hollow and the liquid pump is disposed inside the body portion.

9. An ornamental fountain as claimed in claim 7, further comprising a transformer arranged to supply electrical power to the light emitting device and the liquid pump.

10. An ornamental fountain as claimed in claim 9, wherein the transformer includes a primary winding, a first secondary winding in circuit with the light emitting device, and a second secondary winding in circuit with the liquid pump.

11. An ornamental fountain as claimed in claim 1, wherein the liquid outlet forms part of a nozzle.

12. An ornamental fountain as claimed in claim 1, further comprising a liquid duct connected at a first end to the liquid outlet and connectable at a second opposite end to a liquid pump.

13. An ornamental fountain as claimed in claim 1, further comprising a plurality of light emitting devices, at least one of which is arranged such that during use when electrical power is supplied to the light emitting device, the light emitting device emits light in a direction which intersects with the liquid stream and at least a portion of the emitted light travels along the liquid stream in the same direction as the liquid stream.

14. An ornamental fountain as claimed in claim 1, wherein the light emitting device is a halogen lamp or at least one light emitting diode.

15. An ornamental fountain as claimed in claim 1, wherein the light emitting device is arranged to emit coloured light.

16. An ornamental fountain as claimed in claim 1, wherein the body portion is configured so as to resemble a fish.

17. An ornamental fountain as claimed in claim 1, further comprising at least one rechargeable battery and a solar power converting device arranged to convert solar power to electrical power and thereby generate a recharge current useable to recharge the at least one rechargeable battery during daytime.

18. An ornamental fountain as claimed in claim 17, wherein the solar power converting device is at least one solar panel.
